(19) United States
(12) Patent Application Publication
(10) Pub. No.: US 2006/0091238 A1
(43) Pub. Date: May 4, 2006

(54) Domestic spraying device

(76) Inventors: Susan Michelle Kutay, Burnaby (CA); Richard Leslie Wright, Wirral (GB)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(21) Appl. No.: 10/517,930

(22) PCT Filed: Jun. 6, 2003
(86) PCT No.: PCT/EP03/06031

§ 371 Date: Aug. 18, 2005

(30) Foreign Application Priority Data
Jun. 14, 2002 (GB) 0213781.8

(51) Int. Cl. B05B 9/04

(52) U.S. Cl. 239/373; 239/337

(57) ABSTRACT

A hand-held domestic spraying product comprising a reservoir (2) holding a liquid composition (3), a nozzle means (17) for producing a spray from said liquid composition, an electrically powered pump (4) for creating the force required to move the liquid composition from the reservoir towards the nozzle, and a control means for activating the electrically powered pump (4), characterised in that the electrically powered pump (4) is a MEMS pump.

The present invention relates to a hand-held domestic spraying device and product that utilises a MEMS (micro-electro mechanical system) pump to force a liquid composition from a reservoir towards a spray nozzle.

Hand-held domestic spraying devices of the prior art have utilised a variety of means for transferring a liquid composition from a storage reservoir towards a spray nozzle. A widely used option has been to use volatile propellants, such as liquefied hydrocarbons or chlorofluorocarbons, to pressurise the liquid composition. However, it is increasingly recognised that the addition to the atmosphere of VOCs/greenhouse gases may have detrimental environmental consequences.

An alternative means of supplying the necessary force to the liquid composition has been the use of hand-powered mechanical mechanisms, such as squeeze spray and trigger spray devices. Unfortunately, such mechanisms suffer the inherent problem of requiring physical effort on the part of the consumer. In addition, devices utilising such mechanisms tend not to produce good quality sprays.

The problems of the above approaches have been overcome by the use of electrically powered pumps. Such pumps may be used directly on the liquid composition or they may be used as air pumps—the resulting air pressure modification providing the force required to move the liquid composition. EP 949,006 A1 (Procter and Gamble) describes the use of an electrically powered pump to directly move a liquid cleaning composition from a reservoir towards a spray nozzle. U.S. Pat. No. 3,522,911 (Collins) and U.S. Pat. No. 4,034,916 (Helene Curtis) describe the use of electrically powered air pumps as compressors, supplying pressurised air that is used to force a liquid composition from a reservoir towards a nozzle. WO 99/49904 (Quest International) describes the use of an electrically powered air pump to create an air stream that draws a liquid composition from a reservoir using a venturi effect.

The problem with electrically powered pumps, as described above, is that they are generally relatively expensive and bulky. In addition, their power consumption can be quite high. As a result, traditional electrically powered pumps are not ideal for use in disposable, hand-held, domestic spray products. For this reason, devices that utilise such pumps have previously been envisaged as non-disposable products, requiring re-fill packs of the liquid composition to be dispensed in order to be economically viable.

We now have found that a hand-held domestic spray product utilising an electrically powered pump may be made using a MEMS pump. Such products have all the benefits of electrically powered pumps described above and the further benefits of being relatively inexpensive and light. In addition, the relatively low cost and size of such products makes them potentially disposable and not tied to use with re-fill packs. A further advantage is that such products can produce a spray with very little noise; this can be a valuable benefit in the domestic environment.

MEMS pumps have previous been described for use in military and laboratory applications. WO 00/28215, U.S. Pat. No. 5,836,750, U.S. Pat. No. 6,106,245, and U.S. Pat. No. 5,836,750 (all by Honeywell Inc.) describe such pumps and usage.

### SUMMARY OF THE INVENTION

In a first aspect of the present invention, there is provided a hand-held domestic spraying product comprising a reservoir holding a liquid composition, a nozzle means for producing a spray from said liquid composition, an electrically powered pump for creating the force required to move the liquid composition from the reservoir towards the nozzle, and a control means for activating the electrically powered pump, characterised in that the electrically powered pump is a MEMS pump.

In a second aspect of the present invention, there is provided a method of spraying a liquid composition using a product as described in the first aspect of the invention.

### DETAILED DESCRIPTION

The hand-held spraying product of the present invention may be used with numerous liquid compositions and for many domestic applications. It is particularly suitable for application of cosmetic compositions, which are generally applied directly to the human body. Examples of such cosmetic compositions include hair sprays, perfume sprays, deodorant body sprays and underarm products, in particular antiperspirant compositions. The MEMS pump provides a means of moving the liquid composition from the reservoir towards the nozzle and a good spray quality to be produced. A further benefit resulting from the use of an electrically powered MEMS pump is that the spray product is comparatively energy efficient, the MEMS pump having a relatively low power consumption. The above benefits are independently and collectively advantageous for liquid cosmetic compositions that have to be applied to the human body, where it is desirably to be able to apply the composition quickly in the form of a good quality spray and also to have a product that does not quickly run out of power.

Any type of MEMS pump may be used in the spray product of the invention. The pumps are characterised by comprising micro-channels having sub-millimeter diameters and operating using electrostatic pressure generation. Typical micro-channel diameters are from 1 to 500 μm, in particular from 10 to 300 μm. The pumps are typically fabricated using processes compatible with those used in semi-conductor integrated circuit production. Typical materials of manufacture are silicones and plastics, with the proviso that the material must be capable of being electrically charged. The pumps may operate by positive displacement, the different principles being piston, gear, lobe, mohno, diaphragm, centrifugal, and hose. Micro-peristaltic pumps are another option. The use of diaphragm pumps, where liquid displacement is achieved by the deformation of an elastic membrane, is a preferred option. Diaphragm pumps that are electrostatically driven are particularly preferred, especially those having a plurality of elementary cells, each of said cells comprising a body forming an electrode cavity having at least one electrode having a curved surface facing toward a curved surface on a facing part of said body to define said cavity, said body including electrical activation means for selectively energising said electrode; a diaphragm mounted and grounded in said body under tension and having a major portion located in said cavity between said curved surfaces, said diaphragm being adapted to deflect toward and away from said electrode curved surface; lateral conduit means in said body forming an end conduit, said lateral conduit means being operably connected to the portion of said diaphragm mounted in said body and positioned to be opened and closed by movement of said diaphragm for controlling flow of fluid through said end conduit; vertical conduit means operatively connected to at least one curved surface of said cavity for controlling flow of fluid there through by movement of said diaphragm into and out of contact with said vertical conduit means; and interconnecting conduit means for connecting said cell to said plurality of cells to form said MEMS pump; whereby activation of said electrode causes movement of said diaphragm toward said curved surface of said electrode and deactivation of said electrode allows said diaphragm to return to its original position, to thereby move fluid into and out of said body.

In order to achieve a good transfer rate for the liquid composition, an array of MEMS pumps arranged in parallel may be used, optionally with output micro-channels combining together to give a single chamber. An array of MEMS pumps arranged in series may be used in order to achieve higher pressures. Preferably, the MEMS pumps may be arranged both in parallel and in series in order to achieve both of the above benefits.

The MEMS pump may be used to act directly upon the liquid composition, forcing it towards the nozzle means. In such embodiments, the MEMS pump acts as a liquid pump and is situated either within or adjacent to the reservoir holding the liquid composition or is connected thereto by a conduit which provides for transfer of the liquid composition from the reservoir to the MEMS pump.

In preferred embodiments, the MEMS pump acts as an air pump and results in an air pressure modification adjacent to the liquid composition and thereby provides the force required to move the liquid composition towards the nozzle means. Such embodiments have the benefit that the liquid composition is not in direct contact with the MEMS pump, thereby avoiding any incompatibility problems. This is of particular benefit when the liquid composition has a resistivity of less than 10⁴ ohm.cm, especially when the MEMS pump is a diaphragm pump that is electrostatically driven.

In certain embodiments in which the MEMS pump acts as an air pump, its function is to act as an air compressor, increasing the air pressure adjacent to the liquid composition. The pressure upon the liquid composition then forces it towards the nozzle means, often via a transfer conduit.

In other embodiments in which the MEMS pump acts as an air pump, it acts to create an air stream that serves to draw the liquid composition from the reservoir using a venturi effect. In such embodiments, the air flows through a channel and creates a reduced pressure environment adjacent to the liquid composition, typically at the outer end of a transfer conduit contiguous with the reservoir for the liquid composition. The reduced pressure draws the liquid composition from the reservoir and into the air stream. The cross-sectional area of the transfer conduit for the liquid composition is preferably greater than that of the air flow channel at the point where the two meet—this can lead to enhanced the spray quality. The outer end of the transfer conduit may be considered to be part of the nozzle means (vide infra) in some embodiments.

A problem that may occur with products according to the present invention is that the MEMS pump may produce a pulsing flow, which can be detrimental to spray quality. It is therefore desirable to have a pulse reduction means present. Such means may comprise a parallel array of MEMS pumps, generally a parallel array of MEMS pumps in series, with non-synchronous pulse frequencies, by which it is meant that the frequencies are different or that they are out of phase with one another, preferably producing an even total flow on combined use. In embodiments in which the MEMS pump acts as an air pump, in particular as an air compressor, an alternative or additional pulse reduction means may comprise a buffer chamber for receiving the air from the MEMS pump or pumps. When present, it is preferred that the buffer chamber has a volume of at least half that of the reservoir containing the liquid composition in order to enhance its effectiveness.

The nozzle means is responsible for creating and often directing the spray produced from the liquid composition. The nozzle means may be any of those typically used in the art, ranging from simple exit orifices to more complicated venturi atomisation nozzles. Preferred nozzles comprise a means of increasing droplet break-up beyond that achieved by the passage of the liquid composition through a simple exit orifice. Swirl chambers of the type known in the art are suitable for use in this manner.

The control means for activating the electrically powered pump may be of any appropriate form. Typical examples include push buttons, toggle switches, or slide-operated switches. The activation will typically involve supply of electrical power to the pump.

The source of the electrical power is preferably comprised within the device itself, although an external power supply may be used. The product may comprise a capacitor, battery or photo-voltaic cell as a source of electrical power.

In many embodiments there exists a transfer conduit for transfer of the liquid composition from the reservoir towards the nozzle means. The transfer conduit may have various positions relative to the MEMS pump. When the MEMS pump acts directly upon the liquid composition, the transfer conduit may be located between the reservoir and the pump, between the pump and the nozzle means, or there may be a transfer conduit in both of these locations. When the MEMS pump acts an air compressor, the transfer conduit runs from the reservoir to the nozzle means, the MEMS pump being separately located.

When present, the transfer conduit preferably comprises one or more valves. Such valves may function to prevent leakage of the liquid composition from the reservoir when the pump is not operating. Positive pressure on the reservoir side of the valve or negative pressure on the nozzle side of the valve may cause the opening of such valves.

For hand-held spraying products in which the MEMS pump acts as an air pump, it is preferred that the air pump is able to operate at high air flow rate, for example from 30 L/hr. to 150 L/hr., and, in particular, from 42 L/hr. to 120 L/hr. For such products, the pressure generated by the air pump is preferably from 15 to 40 psig. Such flow rates and/or pressures enhance the spray quality achieved. Spray quality may be defined by the fineness of the droplets achieved and/or by the narrowness of the particle size distribution (p.s.d.) of said droplets. For many applications, it is desirable to achieve a volume mean droplet size of from 1 μm to 100 μm, in particular from 5 μm to 50 μm, and especially from 5 μm to 25 μm. It is desirable that the narrowness of the p.s.d. is such that the D[10] to D[90] spread is from 1 μm or greater to 100 μm or less, in particular from 5 μm or greater to 85 μm or less and especially from 5 μm or greater to 35 μm or less. The droplet/particle size values quoted are as measured by conventional light scattering techniques on instruments such as the Malvern Mastersizer.

Liquid compositions used with the product of the present invention frequently comprise a liquid carrier fluid comprising a C2 to C4 alcohol, for example ethanol, propylene glycol, propanol, or iso-propanol. When such liquid compositions are cosmetic compositions for application to the human body, the good spray quality attained leads to an excellent sensory benefit for the user. Suitable liquid compositions typically comprise C2 to C4 alcohol at a level of from 5% to 95%, in particular from 25% to 80%, and especially from 40% to 75% by weight of the composition. Liquid compositions comprising ethanol are particularly suitable for use with the product of the present invention. In certain embodiments, as described above, it is preferred that the liquid composition has a conductivity of less 10⁴ ohm.cm. Such compositions typically comprise water, for example at a level of from 5 to 95%, in particular from 10 to 80%, and especially at from 20 to 60% by weight of the total composition. Such compositions may also comprise a solubilised aluminium salt, for example at from 0.5 to 20%, in particular from 1 to 15%, and especially at from 2 to 10% by weight of the total composition.

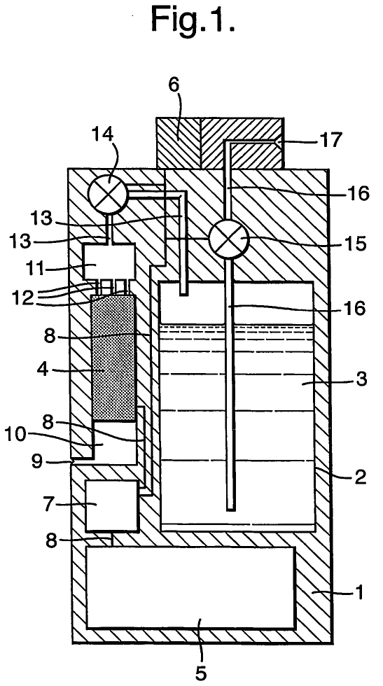

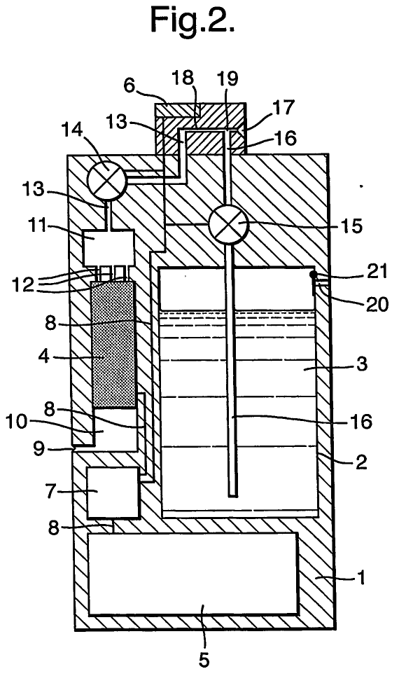

The invention will now be further described by reference to two specific embodiments as represented by FIGS. 1 and 2.

FIG. 1 is a representation of an embodiment in which the MEMS pump acts as an air compressor.

FIG. 2 is a representation of an embodiment in which the MEMS pump acts to create an air stream that serves to draw the liquid composition from the reservoir using a venturi effect.

In FIG. 1, the spray product represented comprises a body (1) within which there is a reservoir (2) for a liquid composition (3), and an array of MEMS pumps (4) arranged in vertical series (20 per series), the series being arranged in parallel (in a 3×3 array). The MEMS pumps (4) are powered by a battery (5) and are activated by pressing a button (6), via an electronic control unit (7) and associated circuitry (8). The MEMS pumps (4) draw air from outside of the device through an inlet valve (9) which opens when the pressure in an entry chamber (10) is reduced by the operation of the MEMS pumps (4). The air is pumped by the MEMS pumps (4) into a buffer chamber (11), through tubes (12) running from the top of each series of MEMS pumps (4). The air in the buffer chamber (11) may be allowed to build in pressure, until it is released to flow through a channel (13) by the opening of a valve (14), which is also controlled by the electronic control unit (7) via the associated circuitry (8).

The air flows through the channel (13) into the reservoir (2) holding the liquid composition (3). When a further valve (15), which is also controlled by the electronic control unit (7) via the associated circuitry (8), is released, the liquid composition (3) is forced up a transfer conduit (16) towards the nozzle (17) where it is atomised and exits as a spray. A vapour phase tap (not shown) is optionally present as part of the nozzle design.

In FIG. 2, many of the features serve the same function as in FIG. 1 and the descriptions given for the features of FIG. 1, apply equally to the features labelled the same in FIG. 2. Differences exist when the air leaves the buffer chamber (11) via air flow channel (13). In the embodiment of FIG. 2, the channel (13) leads directly towards the nozzle (17) via a narrower section of the channel (18). Shortly before this channel (18) reaches the nozzle (17), it passes over the top of a transfer conduit (16) which is of greater cross-sectional area than that of the narrower section of the air flow channel (18) at the point where the two meet. When a valve (15) is opened, the air flow draws the liquid composition (3) up the transfer conduit (16) by a venturi effect. Atomisation of the liquid composition (3) commences at the point (19) where it is hit by the air stream and is further enhanced by the nozzle (17) with the result that a spray issues from said nozzle (17). Negative pressure is not allowed to build on loss of the liquid composition (3) from the reservoir (2)—air is allowed to enter the upper section the reservoir through an air bleed (20) and a ‘vacuum break’ valve (21) which opens when the pressure in the reservoir (2) is reduced.

1. A hand-held domestic spraying product comprising a reservoir holding a liquid composition, a nozzle means for producing a spray from said liquid composition, an electrically powered pump for creating the force required to move the liquid composition from the reservoir towards the nozzle, and a control means for activating the electrically powered pump, characterised in that the electrically powered pump is a MEMS pump.

2. A product according to claim 1, wherein the MEMS pump acts as an air pump resulting in an air pressure modification adjacent to the liquid composition and providing the force required to move the liquid composition from the reservoir towards the nozzle means

3. A product according to claim 2, wherein the liquid composition has a resistivity of less than 10⁴ ohm.cm.

4. A product according to claim 3, wherein the MEMS pump is a diaphragm pump that is electrostatically driven.

5. A product according to claim 2, wherein the MEMS pump acts as air compressor, increasing the air pressure adjacent to the liquid composition.

6. A product according to claim 2, wherein the MEMS pump acts to create an air stream that serves to draw the liquid composition from the reservoir using a venturi effect.

7. A product according to claim 1, comprising a pulse reduction means.

8. A product according to claim 1, comprising a parallel array of MEMS pumps.

9. A product according to claim 1, comprising an array of MEMS pumps in series.

10. A product according to claim 8, comprising a parallel array of MEMS pumps with non-synchronous pulse frequencies.

11. A product according to claim 2, comprising a buffer chamber for receiving the air from the MEMS pump.

12. A product according to claim 11, wherein the buffer chamber has a volume of at least half that of the reservoir containing the liquid composition.

13. A product according to claim 1, comprising a transfer conduit for transfer of the liquid composition from the reservoir towards the nozzle means.

14. A product according to claim 13, wherein the transfer conduit comprises one or more valves.
